(19) United States
(12) Patent Application Publication
(10) Pub. No.: US 2005/0218971 A1
(43) Pub. Date: Oct. 6, 2005

(54) SYSTEM AND METHOD FOR AN AUTO-TRACKING, SELF-CALIBRATING VOLTAGE GENERATOR

(75) Inventor: Brian Elfman, Alameda, CA (US)

Correspondence Address: BAY AREA INTELLECTUAL PROPERTY GROUP, LLC, PO BOX 210459, SAN FRANCISCO, CA, 94121-0459, US

(73) Assignee: B.P. ELFMAN & A.B. POLLARD PROPERTIES LLC, ALAMEDA, CA (US)

(21) Appl. No.: 10/812,523

(22) Filed: Mar. 30, 2004

(51) Int. Cl. G05F 1/613

(52) U.S. Cl. 327/550

(57) ABSTRACT

A self-calibrating an auto-tracking voltage regulation method and system is provided that includes a superior voltage reference and a less stable operating voltage reference. The superior voltage reference may be a thermal resistor heated zener (TRZ) that is turned on only during a relatively low duty cycle sampling period. An error signal generator compares the superior voltage reference and a feedback voltage to generate an error signal based thereon. An error correction unit combines the error correction signal and the operating voltage reference to produce a calibrated output voltage that has a greater voltage stability than the operating voltage reference.

### FIELD OF THE INVENTION

The present invention relates generally to electronic voltage generators. More particularly, the invention relates to precision electronic voltage generators having an auto-Tracking, self-calibration capability.

### BACKGROUND OF THE INVENTION

For many years, the electronics industry has been striving for increasingly better performing regulated voltage references, or generators, that are still relatively cost effective. Recent advances in semiconductor technology have enabled continued improvements towards more accurate, robust, and inexpensive regulated voltage generators.

Historically, voltage standards such as those based on electrochemical techniques have required a significant amount careful maintenance and control. In some instances, they required special hermetically sealed vessels, and temperature controlled chambers. Moreover, if disturbed, they could take the better part of a month to stabilize, and once stabilized, certain kinds of cells run for decades staying within a microvolt of their original voltage measurement. Electrochemical voltage references are known to suffer from high output voltage variance due to parameters such as some combination of absolute voltage, temperature coefficient and aging. Given their well-proven long-term stability such electrochemical voltage standards continue in present use.

The current voltage standard, the Josephson Junction Array (“JJA”), which functions cryogenically—achieves superior performance over its electrochemical predecessor. It is known that the JJA voltage is predicated on a cryogenic physics constant, which results in a voltage standard capable of relative voltage uncertainty of less than 1×10⁻¹⁰ per year. However, because it operates at a temperature of a few K (K=Kelvin—right near absolute zero) only a relatively few labs are able to support a JJA as maintenance costs are prohibitive.

However, for common electronic applications, adequately accurate voltage references are implemented with practical solid-state components often as a complete voltage reference either on a chip or as a hybrid assembly of discrete components. Typically, this class of voltage regulators are known to be relatively inexpensive, quite rugged to the environment, easily installed into a circuit on a printed circuit board (PCB) board, and have proven to be reliable enough for many application. However, it is well known that they have significant accuracy and stability limitations. For example, voltage output drifts over temperature, aging and noise. For at least these reasons, it is known that modern ambient temperature operated solid-state voltage reference components are capable of up to about 18 bit accuracy, compared to the JJA, which is capable of better than 26 bit accuracy.

The current state-of-the-art improves the accuracy of solid-state voltage references to about 20 bits or more by using certain types of “ovenized” reference zener diodes under tight temperature control. Typically, the ovenized zener is encased in a metal header much like a transistor in a TO-5 case with a thermal resistor (Rt). It is heated by an Rt through a thermal control circuit. This configuration is referred to as a thermal resistor heated zener, or TRZ. Some background information of the TRZ may be found in, for example, Jim Williams, et al. “A Standards Lab Grade 20-Bit DAC with 0.1 PPM/C Drift” Linear Technology Corp. Application Note 86 (2001).

The stability of a TRZ may approach a few PPM per year, and with careful selection, TRZ stability of less than 1 PPM per year is possible. Selection requires a grading scheme, which adds significant time and expense. By implementing selective grading, a relatively stable and accurate TRZ voltage standard is known to be possible. Traditional metrology-level test instruments are known to mostly employ substantially the same TRZ and grading practice.

Hence, there is a void between the cost effective TRZ at about 20 bit accuracy and stability and laboratory-quality voltage standards at better than 26 bit accuracy and stability. It would be desirable if there was an approach that maintains the practicality of the TRZ, yet distinctly improves its performance, towards achieving at least the stability of an electrochemical laboratory-quality voltage standard.

Another drawback of the TRZ is that it is not capable of being recalibrated. Thus, to set a specific voltage reference output, external circuitry is required such as resistor divider networks. However, the additional external circuitry not only increases cost and space usage, but, often more importantly, can significantly reduce the TRZ's basic voltage accuracy and stability.

Methods are known that attempt to overcome this drawback. Some approaches avoid using external circuitry by providing multiple outputs, which can be derived from the constant TRZ voltage source.

A potentiometer arrangement offers a possible solution. However, such arrangement also suffers from problems in maintaining long-term stability over several decades of voltage and may necessitate complex precision resistor circuits such as the Kelvin-Varley Divider and its variants.

Moreover, when a TRZ is designed into a long scale need, at 20 bits or more, drift and noise become dominant performance limiters. The difficulty setting a specific TRZ voltage over several decades in high precision circuit designs (e.g., 24 bits or better) includes the following principal limiting factors:
a) the TRZ has a range of direct voltage outputs—a typical TRZ has an output voltage range of 7.0 to 7.2 volts.;
b) scaling resistors used in the voltage outputs—these resistors are subject to production tolerances and drift factors and are relatively difficult to match to the TRZ voltage output; and
c) the voltage output is subject to voltage drops upon loading, typically in the micro volt range; thus, certain digits must be increased to account for the connection voltage drops

These design limitations present a challenge to a long scale design especially where in setting the least significant digits of a voltage output—significant voltage drops occur over circuit connections and/or connectors. The problem is further compounded where if a specific voltage over several decades is set. minute changes of resistor values such as Tc (temperature) and aging in the scaling resistor networks will cause the voltage output to vary, notwithstanding if the output load changes.

In U.S. Pat. No. 5,369,245 (1994) by J. R. Pickering of Metron Designs Ltd. (Great Britain) “Method and Apparatus for Conditioning Component Having a Characteristic Subject to Variation With Temperatures” Discloses a recovery scheme from an undesirable output change of a TRZ caused by inadvertent ambient temperature changes. A TRZ may exhibit undesirable output variations when subjected to temperature extremes. Pickering has provided a method to counteract such changes by applying a short series of diminishing temperature-controlling pulses.

FIG. 1 shows a TRZ based voltage reference. A typical TRZ 1 generates a TRZ output voltage 15, which is passed through a scalar 5 and a buffered output amplifier 10, thereby producing a buffered voltage output 11. The scalar 5 can be a simple resistor divider network. Buffered output amplifier 10 may be a precision op amp depending on the application. Other implementations, including a TRZ current and temperature control, are provided in Williams, and FIG. 1 of '245.

In P. J. Spreadbury. “The Ultra-Zener—A Portable Replacement for the Weston Cell?” IEEE Transaction Instrument Measurement Vol. 40, No. 2, April 1991. A series of experiments were performed on competitive TRZs; including the same model as is used in Pickering '245 above. Spreadbury “aged” these TRZs over periods of months and years. By aging, he set the temperature control to a range of specific temperatures over a starting period of six months. Spreadbury demonstrates how temperature has a dominant influence on the TRZ output voltage performance. Thus, the resistor ratios that set the temperature control of Rt (see above) substantially control temperature variation, and thereby enable the designer to control a TRZ's output voltage drift, to a certain extent, by manipulation of temperature Rt over time. From these experiments, Spreadbury identified two kinds of TRZs. Those that are powered continuously are subject to aging of a few PPM per year drift, and those that are unpowered (except the time for measurement) show virtually no drift. Spreadbury found that for a continuously powered TRZ, drift over time diminishes significantly.

In some cases, ultimately under 1 PPM per year. Moreover, Spreadbury teaches that a relatively unpowered TRZ ages very little, even when turned on for eight hours.

Pickering (Metron Designs, Ltd.) followed '245 above with U.S. Pat. No. 6,342,780 (2002) “Zener diode reference voltage standards” a method to control a TRZ cathode to anode current is disclosed. Citing Spreadbury above, Pickering discloses a method to alternate current (I) values across the TRZ to balance out heat rise against voltage output accuracy and reduce 1/f noise.

In view of the foregoing, there is a need for improved techniques for a method and apparatus to self-calibrate and auto-track a long scale voltage generator for precision applications including a voltage reference and power supply.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a prior art TRZ type voltage reference with a scalar and output amplifier;

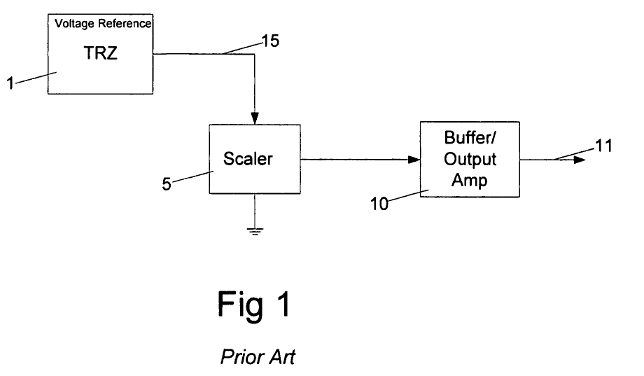

FIG. 2a illustrates a block diagram of a first part of two parts of an embodiment of the present invention;

FIG. 2b illustrates a block diagram of a second part of two parts of an embodiment of the present invention;

FIG. 2c illustrates a flow chart of the voltage regulation method in accordance with an embodiment of the present invention;

FIG. 3a illustrates a block diagram of another embodiment of the present invention; and

FIG. 3b illustrates block diagram showing the relation between both the self-calibrate and auto-tracking modes according to an embodiment of the present invention.

FIG. 4 illustrates a block diagram of still another embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of embodiments for improving accuracy over time and stability are described.

In one embodiment of the present invention, a self calibrating voltage regulation system is provided that includes a superior voltage reference and an operating voltage reference, which operating voltage reference distinctly has more voltage drift over time than the superior voltage reference, an error signal generator configured to be in communication with both the superior voltage reference and the operating voltage reference the error signal generator being further configured to generate an error signal based thereon. In this embodiment, an error correction unit is configured to be in communication with both the error correction signal and the operating voltage reference, the error correction then generates a calibrated output voltage that has a greater voltage stability than the operating voltage reference.

Alternative embodiments may have the superior voltage reference that includes a thermal resistor heated zener (TRZ) that is turned on during a sampling period and is otherwise essentially turned off, wherein the duration of the sampling period is selected to provide the superior voltage reference distinctly more voltage stability over time than the operating voltage reference.

In some embodiments of the voltage regulation system, the error signal generator includes an error comparison unit configured to be in communication with both the superior voltage reference and the feedback voltage and outputs a raw error signal that selectively stored in either a seed storage unit or a calibration storage unit as determined by a storage control unit. A correction comparison unit is also included that is in communication with both the seed storage and calibration storage units. The correction comparison unit outputs an error correction signal, which is based on comparing the values stored in the seed storage and calibration storage units. Furthermore, depending on the application, alternative embodiment may have the output voltage calibrated during a sampling period, whereby the time between successive sampling periods is selected to maintain the output voltage calibration to within a desired tolerance. In some applications, the feedback voltage is derived from the output voltage.

In certain embodiments, the error comparison unit includes an analog difference amplifier, and have the seed storage and calibration storage units implemented as digital storage registers. Yet other embodiments implement the comparing done by the correction comparison unit as a digital subtraction, whereby the error correction signal is an analog signal substantially corresponding to the result of the digital subtraction of the seed storage and calibration storage units. When appropriate, the error correction unit may include a summing amplifier.

Another embodiment of the present voltage regulation system, the error signal generator is remotely located away from the error correction unit and the communication of the error correction signal to the error correction unit occurs via suitable communication means.

In another aspect of the present voltage regulation system, an auto-tracking means is provided to set the output voltage reference to a specific voltage, whereby the error correction unit maintains the specific voltage.

A method is also provided for the self-calibrating and auto-tracking of an output voltage to be regulated. An embodiment of this method includes the steps of turning on a superior voltage reference during a sampling period and otherwise turning it essentially off, setting the duration of the sampling period to provide the superior voltage reference substantially more voltage stability than an operating voltage reference, generating a raw error signal based on the superior voltage reference and a feedback voltage, and then calibrating the output voltage based on the error correction signal and the operating voltage reference. A result is that the calibrated output voltage has greater voltage stability than the operating voltage reference. Some alternative embodiment of this method do the calibration of the output voltage during the sampling period, whereby the time between successive sampling periods is selected to maintain the output voltage calibration to within a desired tolerance.

In yet other embodiments of the present voltage regulation method, the step of generating the error correction signal includes the steps of subtracting the superior voltage reference and the feedback voltage to generate an analog difference signal, digitizing the analog difference signal, initializing a seed storage register to a preset value corresponding to a target regulation voltage to maintain, storing the digitized analog difference signal in a calibration storage register; and generating the error correction signal by subtracting the seed and calibration digital storage registers.

Depending on the particular application, alternative embodiments of the present voltage regulation method further have the step calibrating the output voltage to include the step of adding together the error correction signal and the operating voltage reference to generate the calibrated output voltage. Other embodiments further include the step of scaling and/or buffering the calibrated output voltage to a desired voltage value.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

An aspect of the present invention provides a system and method for leveraging a voltage reference with superior drift over time to substantially improve an operating voltage reference that has distinctly more voltage drift over time, which is herein referred to as an operating (prime) TRZ, or PTRZ. The voltage reference with superior drift over time is referred to as a “superior” TRZ, or STRZ, in the described embodiment. Thus, the STRZ defines a class of references that, among other things, is superior in voltage drift compared to the PTRZ. The degree of superiority considered substantial enough to be superior, as those skilled in the art will readily recognize, depends on known practical considerations of the particular application. In the present aspect, a STRZ is leveraged in accordance with the teachings of the present invention to automatically compensate the voltage output of the PTRZ such that the compensated output voltage approximates the precision of the STRZ. The present automatic compensation approach is referred to herein as PTRZ self-calibrating.

Although the described embodiments show by way of example a TRZ implementation for a voltage reference superior in drift over time, those skilled in the art will recognize that any voltage reference having substantial stability advantages in comparison to the working reference is considered to be superior, and, hence, one could call a high precision voltage reference. Likewise, a TRZ implementation of the operating reference is shown by way of example in the described embodiments, however, those skilled in the art will recognize that any voltage reference having substantial stability disadvantages in comparison to a working reference could be considered the working voltage reference to be automatically corrected to approximate the precision of the high precision voltage reference in accordance with the teaches of the present invention.

In a first embodiment of the PTRZ self-calibrating aspect of the present invention, a PTRZ periodically is compared by electronic means to one or more STRZ references. The comparison is done by sampling the difference between the STRZ and PTRZ. This difference is then applied as feedback to correct the output voltage of the PTRZ reference. That is, self-calibration is achieved by comparing, at the sampling time, the output voltage of the PTRZ (or a voltage derived from the PTRZ) to the STRZ to generate an error voltage correction feedback that is used to regulate the regulated output voltage(s) at a desired voltage set point, i.e., a preset or seed target voltage. By maintaining a target regulation voltage through error voltage sampling, the present embodiment is capable of automatically tracking, or auto-tracking, PTRZ variations and use the present self-calibrating mechanism to correct any tracked PTRZ output voltage errors. In an aspect of auto-tracking, the regulated output voltage is set to a specific value and is maintained at substantially that level by the present self-calibrating mechanism.

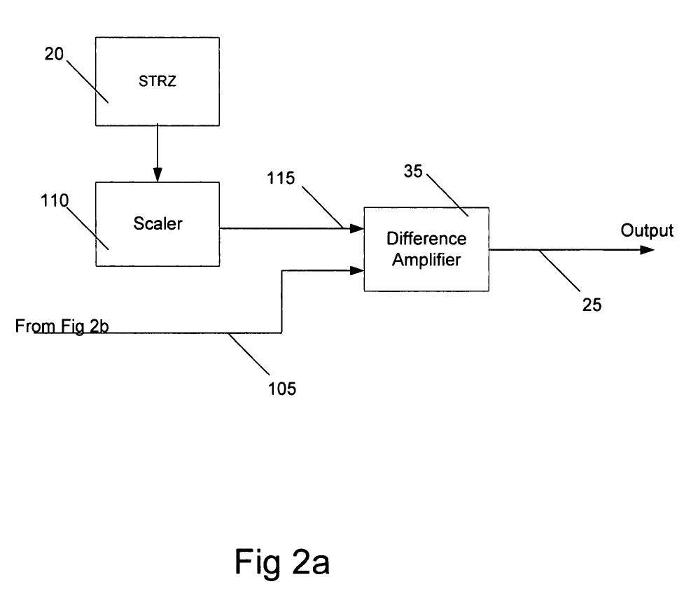

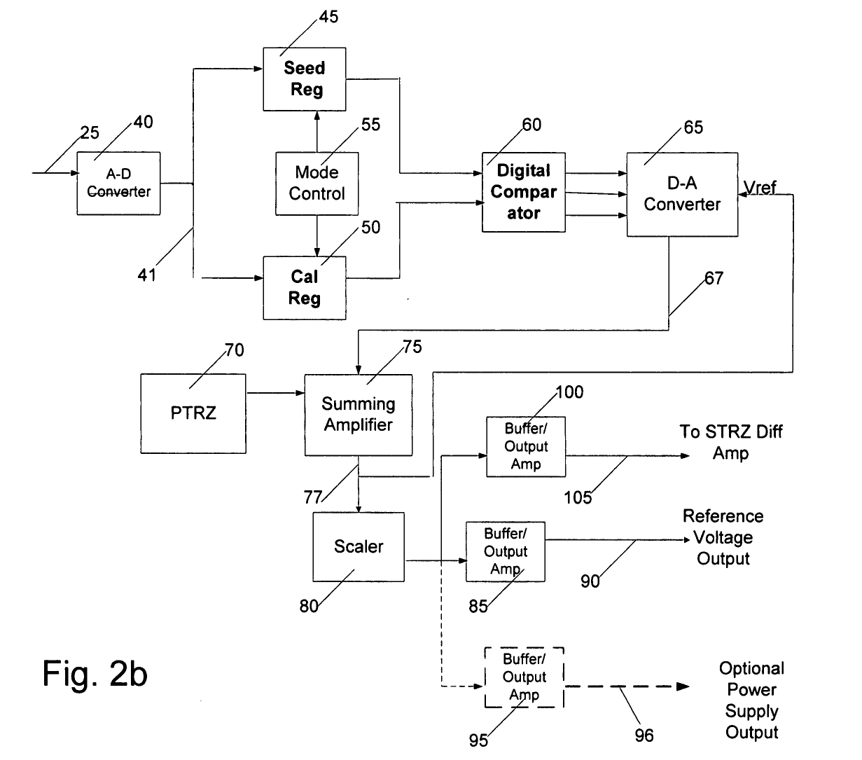

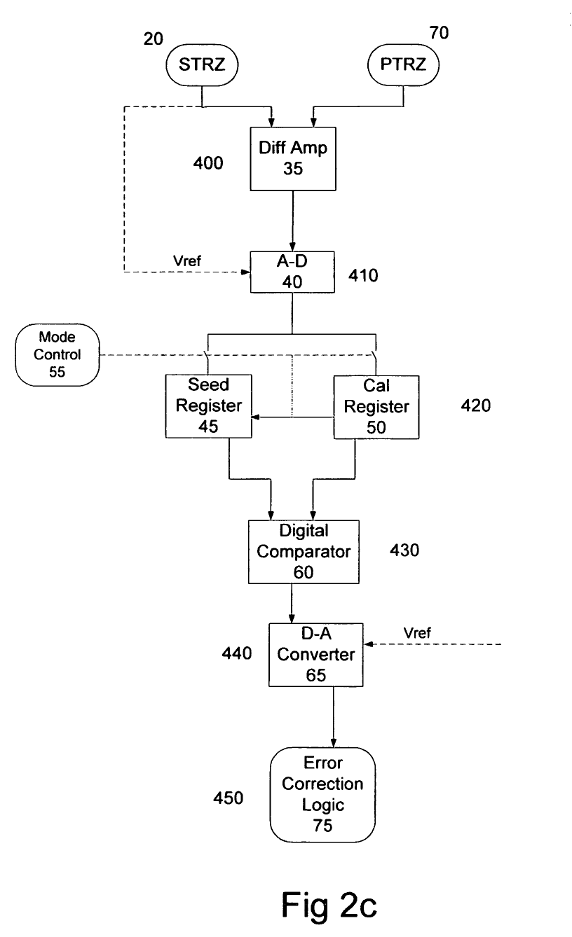

Those in the art will appreciate that the self-calibration and auto-tracking aspects of the present embodiment may be implemented in a multiplicity of alternative embodiments. An implementation of the present embodiment is shown by way of example, and not limitation, as the block diagram of FIGS. 2a & 2b. The blocks shown in the Figure may be implemented using commonly available analog and digital devices. FIG. 2a, is the error signal generation portion of the present embodiment and FIG. 2b is the PTRZ regulation portion thereof. STRZ 20 and PTRZ 70 could be implemented using the LM199 as sold by National Semiconductor of Santa Clara, Calif. Another type of suitable TRZ is the LTZ1000 by Linear Technologies of Milpitas, Calif. Those in the art will readily be able to select the proper TRZ in accordance with the teachings of the present invention. For example, in particular application, STRZ 20 and PTRZ 70 could both be the LTZ1000 TRZ. Some operating details of the present embodiment follow.

In FIG. 2b, a seed register 45 contains a digital representation of a reference voltage 90. Initialization of seed register 45 will be described in some detail after the present system operation description. Reference voltage 90 is the target regulation voltage. The initial digital representation (the starting point voltage) is based on an error signal 25. Error signal 25 is derived by the voltage comparison between PTRZ 70 and STRZ 20 performed by a comparison amplifier 35. In some implementations, error signal 25 may be a few microvolts in amplitude. In some embodiments, error signal 25 is simply the difference in voltage between a scaled STRZ voltage 115 and the feedback of reference voltage 90. The practice of voltage comparison between two precision voltages is well known to those in the art. In particular, those in the art will know how to configure comparison amplifier 35 to achieve a desirable error signal 25 depending on the particular application requirements. The output voltage of comparison amplifier 35 is then digitized by an analog to digital (A-D) Converter 40. The digital output of A-D converter 40 is loaded into one of two registers, either seed register 45 or a calibration register 50 based on a mode of operation as determined by a mode control unit 55. In some alternative embodiments, seed register 45 may be initialized to the digital value corresponding to a preset, or seed, target voltage value, whereby the error signal generation path comprised of digital comparator 60 and D-A converter 65 generates an error correction feedback signal that is used by correction amplifier 75 to regulate the regulated output voltage(s) at the desired voltage set point substantially determined by the seed value.

The present embodiment has two modes of operation. A first mode is calibration initialization. The first mode may be used as a starting voltage point of the PTRZ. A multiplicity of starting voltage points is contemplated, and yet others will be readily apparent to those skilled in the art. By way of example, and not limitation, one kind of starting point is when the unit is checked out at the factory prior to shipment. Yet another kind of starting point may be when the reference is repaired. Still another kind of starting point could be periodical monitoring; that is, an outside recalibration of the reference. A second mode is for the self-calibrate function. Mode control unit 55 accomplishes the necessary switching between modes. Mode control unit 55 may be implement the mode switching scheme by way of, for example, conventional digital multiplexing logic to direct error signal 25 to the appropriately register. In some embodiments of the present invention, mode control unit 55 is additionally configured to include a presettable, real-time clock to enable the control logic to control the mode based on time. It should be understood that while a finite state machine implementation of mode control unit 55 was described, mode control unit 55 could also comprise a general purpose computing machine, such as, for example, conventional central processing units in computers, running the appropriate mode control program, e.g., using software, firmware, or hardware. Thus, those in the art will readily be able to configure mode control unit 55 using known logical or algorithmic means to suitably implement its mode control function. Moreover, depending on the particular application other suitable modes of operation will be apparent to those in the art, whereby the control logic of mode control unit 55 would be readily configured appropriately.

At sampling times, (by way of example, and not limitation, perhaps every 500 hours or every 100 hours or every 1000 hours) the seed register 45 is compared to calibration register 50 by a digital comparator 60, whereby the comparison result, for example, the mathematical difference between the two registers, is converted by a digital to analog (D-A) converter 65, which generates an analog correction signal 67. In certain applications, the resolution of the D-A converter 65 of 10 bits is acceptable, which provides a range equal to, if properly scaled, about +500 microvolts or a full 1000 microvolts.

A correction amplifier 75 then appropriately combines correction signal 67 and the output voltage of PTRZ 70 to produce a corrected voltage 77. An embodiment of correction amplifier 75 may be an analog-summing amplifier. Alternative embodiments of correction amplifier 75 are contemplated and yet others are well within the skill of those in the art to properly configure to appropriately use correction signal 67 to produce corrected voltage 77. Depending on the application, a PTRZ scalar block 80 may be included to scale corrected voltage 77 to a desired voltage. Scalar blocks 80 and 10 may be implemented in a multiplicity of known and suitable ways, by way of example, and not limitation, to comprise precision resistors, which may be procured, for example, from Alpha Electronics Corporation of America. (Minneapolis, Minn.). Moreover, for noise filtering, those in the art will appreciate that analog signals such as error signal 25 and correction signal 67 may require the appropriate selection, according to known design principles, of low leakage, high reliability solid tantalum electrolytic capacitors, which may be procured from Vishay Inc. (Atlanta, Ga.). Some embodiments of the present invention may require an output buffer amplifiers 85, 95, and 100 to buffer an optional output supply voltage 96, reference voltage 90, and/or error correction feedback voltage 105. The selection, purpose, and configuration of these output buffer amplifiers are well known to those skilled in the art. Output buffer amplifier 95 of FIG. 2b is available to be used as a precision power supply 96; however, some embodiments in accordance with the teachings of the present invention do not include it when it is not required. Comparison amplifier 35 can be one of numerous available (off-the-shelf) precision instrumentation amplifiers available from Analog Devices Inc. of Mass., or Linear Technology of Milpitas, Calif. or Burr-Brown, a unit of Texas Instrument of Texas. An example for Summing Amplifier 75 is the Analog Devices Inc. AMP03 or equivalent.

It is contemplated that those skilled in the art may add a variety of signal conditioning elements to the present embodiment while remaining within the scope of the present teaching. For example, in some embodiments (not shown) the output of the PTRZ is buffered by an op amp and scaled with a D-A converter. Thus, such option combines Converter 65 with Scalar 80, which is thereby eliminated. This would also eliminate the need for a Summing & Difference Amplifier 75. Moreover, less stringent component tolerances may be implemented according to an aspect of the present invention.

Regarding digital comparator 60, which outputs the digital difference between seed register 45 and calibration register 50, the means to implement the required logic is well known and commonly available. By way of example, and not limitation, the system designer could use adder/subtractor logic or binary synchronous counters which require clocking. By way of further example, those in the art will readily appreciate a multiplicity of alternative means including the use of binary counters to supplement a general or special purpose computer where lookup tables containing preset variables can be configured to properly modify the content of seed register 45 and calibration register 50. That is, voltage anomalies, including those caused by the common drifting of PTRZ 70 and D-A converter 65 and PTRZ scalar block 80, would be preset into a look-up table of self-calibration parameters. Suitable binary counters include the 74SN190 (a generic model number) synchronous counter series.

For this embodiment, selecting the auto-tracking, sampling duration and frequency that the self-calibrating aspect of the present invention should be enabled can be readily derived by those in the art based on the Spreadbury experiments as referenced to in the Background section above. The sampling duration and frequency in a preferred embodiment is preferably selected such that the TRZ effectively operates in its relatively “unpowered” mode as taught in Spreadbury. Thus, a relatively “unpowered” mode TRZ thereby operating in a STRZ role, based on the nature of this greatly diminished aging factor, provides a skilled artisan a basis on which to establish a trade-off of STRZ operating duty cycle, i.e., time-on versus time-off. For example, in some cases, turning-on the STRZ for eight hours per measurement each 500 hours translates to an effective aging of about 6 days per year as compared to an effective aging of a year if it were turned on continuously.

The present embodiment enables reference voltage 90 to perform as a precision power supply. Many applications require that reference voltage 90 be continuously available, thereby incurring voltage drifts because PTRZ 70 is being powered on continuously. It is at least this voltage drift and common linearity errors that the self-calibrating aspect of the present invention corrects. Hence, another aspect of the present invention is that PTRZ 70 can use less costly, higher tolerance components as all drift can be corrected at the output by the self-calibrating aspect of the present invention. Moreover, selection (grading) of the PTRZ 70 is likewise less critical, thereby providing the opportunity to avoid the associated costs and inefficiencies.

It should further be appreciated that a PTRZ operating in accordance with the present invention is the operating reference for a circuit and it may or may not be powered-up full time, depending on the particular application. Moreover, in the present embodiment of FIG. 2a, a STRZ is capable of substantially more stability and less drift at least because it is powered-up in a preferred embodiment only for the self-calibrating or auto-tracking modes.

In the first embodiment correction feedback voltage 105 is shown as coming from output buffer amplifier 100, this is desirable when the voltage to be self-calibrated is reference voltage 90 at least because all the errors contributed by circuitry between PTRZ 70 and reference voltage 90 are corrected. However, alternative embodiments (not shown) may connect the correction feedback voltage to other analog voltage reference locations to regulate according to them in a similar manner as described for reference voltage 90.

In some embodiment of the present invention the PTRZ working reference may be adjusted in very small voltage increments, for example in microvolts, to offset drifts determined in the comparison process between the superior reference and the working reference.

FIG. 2c illustrates a flow chart of the voltage regulation method in accordance with the first embodiment of the present invention. In the Figure, the modules of the first embodiment are shown with like numerals referring to like references therein. In the present method of the PTRZ self-calibrating aspect, at Step 400 PTRZ 70 is periodically is compared by electronic means to one or more STRZ 20 references. The comparison is done by comparison amplifier 35, which takes the difference between the STRZ and PTRZ. This difference is digitized at Step 410 and then is appropriately stored at Step 420 into calibration register 50 or mode control unit 55 as determined by mode control unit 55. At step 430, digital comparator 60 compares these registers and produces a digital correction signal that is converted to an analog correction signal at Step 440, which is communicated to error correction logic, such as correction amplifier 75, thereby correcting the output voltage of the PTRZ reference. By maintaining a target regulation voltage through error voltage sampling, the present method is capable of automatically tracking, or auto-tracking, PTRZ variations and use the present self-calibrating mechanism to correct any tracked PTRZ output voltage errors. The details of the present method are set forth in the functional descriptions of FIGS. 2a & 2b. Similarly, the described alternative embodiments therein, likewise, apply to the present method embodiment. Those in skilled the art will readily recognize a multiplicity of variations to the present method in accordance with the teaching of the present invention. For example, in some embodiments, the PTRZ and STRZ are electronically swapped.

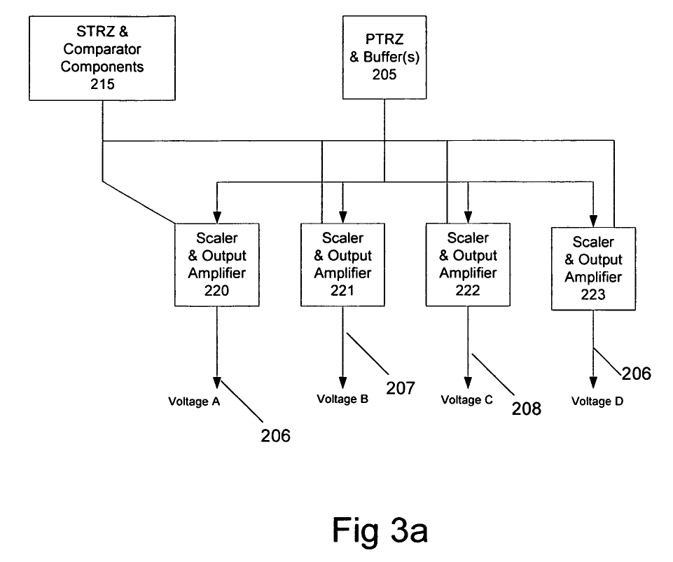

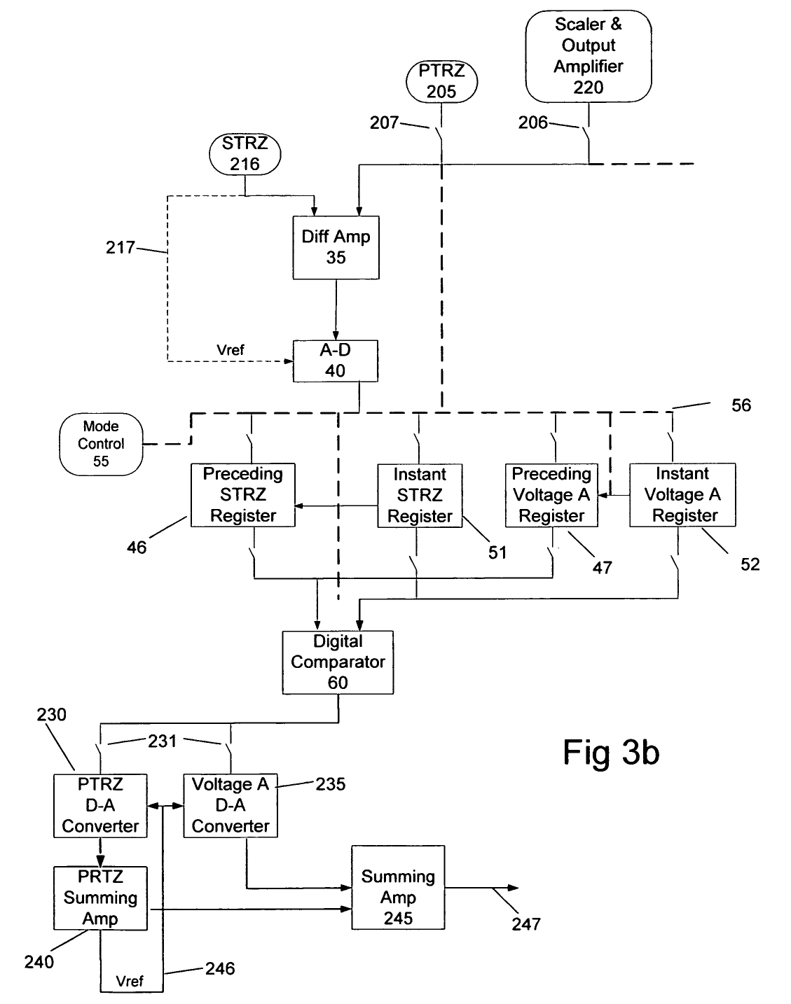

Having described an example in FIGS. 2a & 2b for correcting voltage drift of a single voltage reference, the attendant principles therein may be embodied to track multiple voltage outputs as illustrated by way of example in a second embodiment of FIG. 3a in accordance with the principles of the present invention. In the Figure, the PTRZ 205 is corrected first and then each succeeding voltage output 206-209 is tracked in turn by STRZ 215. The present second embodiment implements the teachings of the first embodiment with the addition of appropriately configured registers corresponding to voltage circuit 220-223.

FIG. 3b illustrates block diagram showing the relation between both the self-calibrate and auto-tracking modes according to an embodiment of the present invention. The present embodiment combines both the self-calibrate and auto-tracking modes as controlled by mode Control unit 55, which enables the appropriate switches 206, 207, 56, and 231 for each type of operating mode.

For reasons of clarity, however, Seed Register 45 and Cal Register 50 in FIGS. 2a-2c are renamed to a Preceding STRZ Register 46 and an Instant STRZ Register 51, respectively. Both of these registers are in communication with Diff Amp 35 and A-D 40. Preceding STRZ Register 46 and Instant STRZ Register 51 are configured as inputs to Digital Comparator 60. Given that auto-tracking relates to correcting a specific output voltage, likewise there are the Preceding Voltage A Register 47 and Instant Voltage A Register 52. That is, further specific voltage outputs 208 would in turn require at least two registers each.

In a preferred embodiment, a Vref 217 is provided as a voltage reference (Vref) to A-D Converter 40. Vref 217, preferably, is derived from STRZ 216. In this embodiment, both PTRZ D-A Converter 230 and Voltage D-A Converter 235 receive their Vref signal from a PRTZ Summing Amp 240 by way of Vref 246. In should be noted that Summing Amp 245 is comparable to Summing Amp 75 in FIG. 2c.

In an embodiment of present self-calibrate and auto-tracking process, the STRZ is corrected before each tracking of the Voltage A 247. This ensures that the Voltage A D-A Converter 235 provides an accurate corrective reference.

Blocks PTRZ 205 and Scalar & Output Amplifier 220 are representative only and those in the art will recognize a multiplicity of alternate implementations. For example, and not by limitation, additional implementation details may be found in the description and illustration of FIG. 2c.

Similar to the first embodiment, some implementations of the second embodiment may comprise a general or special purpose computer control to implement mode control unit 55 of FIG. 2b. Those skilled in the art will readily recognize how to apply the foregoing teachings to properly configure the present second embodiment. For certain alternative embodiments, particularly those similar to the present second embodiment, a STRZ can be used interchangeably for auto-tracking a specific voltage setting and at the same time self-calibrate the operating PTRZ.

In yet other embodiments (not shown), there could be more than one of either the PTRZ or STRZ. By way of example, and not limitation, an implementation of the present invention may have two STRZs and a PTRZ or even visa-versa.

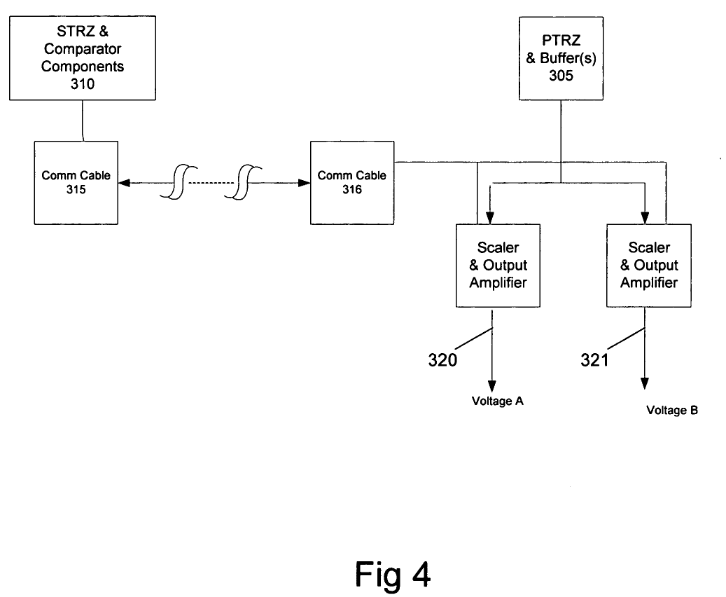

FIG. 4 illustrates a third embodiment where the PTRZ 305 is remotely located away from STRZ 310 via a STRZ communication means 315 and PTRZ communication means 316. By way of example, and not limitation, these communication means may be implemented by any suitable communication means including any combination of a copper or equivalent metal cable, optical cable, and wireless communication.

In the third embodiment, to effect correction of the voltage output, one approach is a two-step process. The first step is to correct the PTRZ 305 itself. The second step is to then correct the output(s) 320 (321). In particular, the PTRZ 305 output of the reference 320 or the PTRZ 305 is measured, digitized and sent over to the STRZ 310. In some alternative embodiments, the correction factor is preset through a look-up table containing all the variable factors of the PTRZ circuitry controlled by a general or special purpose computer or state machine. Once PTRZ 305 is corrected, then the process is repeated except that the operating data, instead, is received from the voltage output. Now the voltage drift of voltage outputs 320-321 may be corrected given that PTRZ 305 was corrected beforehand. Thus, the superior and operating references need not be physically in the same package, on the same printed circuit board, or even within the same physical piece of equipment as the operating reference. Furthermore, the prior teachings of the second embodiment also apply to the present third embodiment whereby the superior reference could be used to compare to any other number of operating references. For example, several pieces of equipment containing operating references could be compared to a central superior reference that need not need to be in the same physical rack or locale.

Having fully described at least one embodiment of the present invention, other equivalent or alternative methods of self-calibrating and auto-tracking voltage reference according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A self calibrating voltage regulation system comprising:
a. a first voltage reference;
b. a second voltage reference, which has substantially less voltage stability than the first voltage reference;
c. an error signal generator configured to be in communication with both the first voltage reference and a feedback voltage, the error signal generator being further configured to generate an error signal based thereon; and
d. an error correction unit configured to be in communication with both the error signal and the second voltage reference, the error correction unit being further configured to generate a calibrated output voltage that has a greater voltage stability than the second voltage reference.

2. The voltage regulation system of claim 1, wherein the error signal generator comprises:
a. a first comparison unit configured to be in communication with both the first voltage reference and the feedback voltage, the first comparison unit being further configured to output a first comparison signal;
b. a first storage unit configured to selectively receive and store the first comparison signal;
c. a second storage unit configured to selectively receive and store the first comparison signal;
d. a storage control unit configured to control the selective receiving and storage of the first comparison signal in the first and second storage units; and
e. a second comparison unit configured to be in communication with both the first and second storage units, the second comparison unit being further configured to output the error signal, which error signal is based on comparing the values stored in the first and second storage units;

3. The voltage regulation system of claim 1, wherein the first voltage reference comprises a thermal resistor heated zener (TRZ) that is turned on during a sampling period and is otherwise essentially turned off, wherein the duration of the sampling period is selected to provide the first voltage reference substantially more voltage stability than the second voltage reference.

4. The voltage regulation system of claim 3, wherein the output voltage is calibrated during the sampling period, whereby the time between successive sampling periods is selected to maintain the output voltage calibration to within a desired tolerance.

5. The voltage regulation system of claim 3, wherein the second voltage reference comprises a TRZ, which is turned on with a sufficiently high on-time duty cycle such that the output voltage becomes out of calibration.

6. The voltage regulation system of claim 3, wherein the error signal generator comprises:
a. a first comparison unit configured to be in communication with both the first voltage reference and the feedback voltage, the first comparison unit being further configured to output a first comparison signal;
b. a first storage unit configured to selectively receive and store the first comparison signal;
c. a second storage unit configured to selectively receive and store the first comparison signal;
d. a storage control unit configured to control the selective receiving and storage of the first comparison signal in the first and second storage units, the storage control unit being further configured to synchronize the selective receiving with the sampling time; and
e. a second comparison unit configured to be in communication with both the first and second storage units, the second comparison unit being further configured to output the error signal, which error signal is based on comparing the values stored in the first and second storage units;

7. The voltage regulation system of claim 6, wherein the feedback voltage is derived from the output voltage.

8. The voltage regulation system of claim 6, wherein the first comparison unit comprises an analog difference amplifier.

9. The voltage regulation system of claim 6, wherein the first and second storage units are implemented as digital storage registers.

10. The voltage regulation system of claim 9, wherein the comparing done by the second comparison unit is a digital subtraction, whereby the error signal is an analog signal substantially corresponding to the result of the digital subtraction of the first and second digital storage registers.

11. The voltage regulation system of claim 1, wherein the error correction unit comprises a summing amplifier.

12. The voltage regulation system of claim 1, wherein the error correction unit comprises a binary controlled scalar, which scalar appropriately scales the calibrated output voltage to a desired voltage value.

13. The voltage regulation system of claim 1, wherein the error correction unit comprises an output buffer configured to buffer the calibrated output voltage.

14. The voltage regulation system of claim 1, wherein the error signal generator is remotely located away from the error correction unit and the communication of the error signal to the error correction unit occurs via suitable communication means.

15. A self calibrating voltage regulation system comprising:
a. a first voltage reference comprising a thermal resistor heated zener (TRZ) that is turned on only during a sampling period and is otherwise essentially turned off, wherein the duration of the sampling period is selected to provide the first voltage reference substantially more voltage stability than a second voltage reference, which second voltage reference comprises a TRZ that is turned on with a sufficiently high on-time duty cycle such that its voltage becomes out of calibration;
b. an error signal generator configured to be in communication with both the first voltage reference and a feedback voltage, the error signal generator being further configured to generate an error signal based thereon; and
c. an summing amplifier configured to be in communication with both the error signal and the second voltage reference, the summing amplifier being further configured to generate a calibrated output voltage that has a greater voltage stability than the second voltage reference.

16. The voltage regulation system of claim 15, wherein the feedback voltage is derived from the output voltage.

17. The voltage regulation system of claim 15, wherein the output voltage is calibrated during the sampling period, whereby the time between successive sampling periods is selected to maintain the output voltage calibration to within a desired tolerance.

18. The voltage regulation system of claim 15, wherein the error signal generator comprises:
a. an analog difference amplifier configured to be in communication with both the first voltage reference and the feedback voltage, the first comparison unit being further configured to output a first comparison signal;
b. a first digital storage register configured to selectively receive and store the first comparison signal;
c. a second digital storage register configured to selectively receive and store the first comparison signal;
d. a storage control unit configured to control the selective receiving and storage of the first comparison signal in the first and second storage units, the storage control unit being further configured to synchronize the selective receiving with the sampling time; and
e. a digital subtraction unit configured to be in communication with both the first and second digital storage registers, the digital subtraction unit being further configured to output the error signal, which error signal is an analog signal substantially corresponding to the result of the digital subtraction of the first and second digital storage registers;

19. The voltage regulation system of claim 15, wherein the error correction unit comprises a binary controlled scalar, which scalar appropriately scales the calibrated output voltage to a desired voltage value,

20. The voltage regulation system of claim 15, wherein the error correction unit comprises an output buffer configured to buffer the calibrated output voltage.

21. The voltage regulation system of claim 15, wherein error signal generator is remotely located away from the error signal generator and the communication of the error signal to the error correction unit occurs via suitable communication means.

22. A self calibrating voltage regulation system comprising:
a. a first voltage reference means that has substantially more voltage stability than a second voltage reference means;
b. an error signal generating means configured to be in communication with both the first voltage reference means and a feedback voltage; and
c. an error correction means configured to be in communication with both the error signal generating means and the second voltage reference means, the error correction means being further configured to generate a calibrated output voltage that has a greater voltage stability than the second voltage reference means.

23. The voltage regulation system of claim 22, further comprising an auto-tracking means configured to set the output voltage reference to a specific voltage, whereby the error correction means is configured to maintain the specific voltage.

24. The voltage regulation system of claim 22, wherein the output voltage is calibrated during the sampling period, whereby the time between successive sampling periods is selected to maintain the output voltage calibration to within a desired tolerance.

25. The voltage regulation system of claim 22, wherein the error signal generating means is remotely located away from the error correction means and the communication of the error signal to the error correction unit occurs via suitable communication means.

26. A method the self calibrating and auto-tracking of an output voltage to be regulated, voltage regulation method comprising the steps of:
a. turning on a first voltage reference during a sampling period and otherwise turning it essentially off;
b. setting the duration of the sampling period to provide the first voltage reference substantially more voltage stability than a second voltage reference;
c. generating an error signal based on the first voltage reference and a feedback voltage; and
d. calibrating the output voltage based on the error signal and the second voltage reference, whereby the calibrated output voltage has a greater voltage stability than the second voltage reference.

27. The voltage regulation method of claim 26, further comprising the step of setting the on-time duty cycle of the second voltage reference sufficiently high such that its voltage becomes out of calibration;

28. The voltage regulation method of claim 26, wherein calibrating the output voltage occurs during the sampling period, whereby the time between successive sampling periods is selected to maintain the output voltage calibration to within a desired tolerance.

29. The voltage regulation method of claim 26, wherein generating the error signal comprises the steps of:
a. subtracting the first voltage reference and the feedback voltage, thereby generating an analog difference signal;
b. digitizing the analog difference signal;
c. initializing a first digital storage register to a preset value corresponding to a target regulation voltage to maintain;
d. storing the digitized analog difference signal in a second digital storage register; and
e. generating the error signal by subtracting the first and second digital storage registers;

30. The voltage regulation method of claim 26, wherein calibrating the output voltage comprises the step of adding together the error signal and the second voltage reference to generate the calibrated output voltage.

31. The voltage regulation method of claim 26, further comprising the step of scaling the calibrated output voltage to a desired voltage value.

32. The voltage regulation method of claim 26, further comprising the step of buffering the calibrated output voltage to substantially isolate it electrically from a load.
